(19) United States
(12) Patent Application Publication
(10) Pub. No.: US 2012/0034546 A1
(43) Pub. Date: Feb. 9, 2012

(54) FUEL CELL, FUEL CELL STACK AND METHOD FOR SEALING A FUEL CELL

(75) Inventors: Christian Martin Erdmann, Rudersberg (DE); Eyuep Akin Oezdeniz, Walheim am Neckar (DE); Tobias Lux, Stuttgart (DE)

(73) Assignee: DAIMLER AG, Stuttgart (DE)

(21) Appl. No.: 13/263,382

(22) PCT Filed: Apr. 6, 2010
(86) PCT No.: PCT/EP10/02155

§ 371 Date: Oct. 19, 2011

(30) Foreign Application Priority Data
Apr. 8, 2009 (DE) 10 2009 016 934.2

(51) Int. Cl. H01M 8/24; H01M 8/00; H01M 8/10

(52) U.S. Cl. 429/465; 429/480; 429/535

(57) ABSTRACT

The invention relates to a fuel cell (1) with a membrane electrode assembly (2). The membrane electrode assembly (2) is disposed between two bipolar plates (5, 6) and connected to a sealing element (3). The sealing element (3) and the bipolar plates (5, 6) contact each other with the formation of an abutment region (10). A sliding surface (11) is provided in the abutment region (1), by means of which the membrane electrode assembly (2) disposed between the two bipolar plates (5, 6) can be impacted with a shear stress (15) upon compression of the two bipolar plates (5, 6). The invention further relates to a fuel cell stack with such a fuel cell (1) and to a method for sealing a fuel cell (1).

The invention relates to a fuel cell with a membrane electrode assembly which is disposed between a first distribution element for impacting an anode of the membrane electrode assembly with a fuel and a second distribution element for impacting a cathode of the membrane electrode assembly with an oxidising agent. The fuel cell comprises a sealing element which is connected to the membrane electrode assembly. The sealing element and at least one of the distribution elements are hereby contacted at least in areas whereby an abutment region is formed. Furthermore the invention relates to a fuel cell stack with a plurality of such fuel cells and a method for sealing a fuel cell.

EP 1 614 181 B1 describes a membrane electrode assembly with an integrated seal. A sealing element arranged on an edge of the membrane electrode assembly is formed in a connection region between the seal and the membrane electrode assembly so that sealing material penetrates pores of the cathode or the anode. The porous electrodes are thus saturated in the connection region with the material of the sealing element. In the connection region the sealing material forms a pad, of which the thickness is greater than a thickness of the planar membrane electrode assembly. The sealing material additionally forms a second sealing bead arranged further outwards towards the edge than the pad, whereby a thickness of the sealing bead is greater than a thickness of the pad. If the membrane electrode assembly is arranged with the integrated seal between two bipolar plates the sealing bead is received in grooves of the bipolar plates. The grooves have a width such that besides the sealing bead the pad is also received therein. If the bipolar plates are then compressed the surrounding sealing bead deforms. The sealing bead can be comparatively greatly compressed during compression of the bipolar plates and thereby be deformed without the compression of the sealing element leading to a shear stress in the region of the pad. It is thereby ensured that the compression of the sealing element does not lead to a detachment of the seal from the membrane electrode assembly in the connection region. A chamfer is formed on the pad which is brought into abutment with a chamfer formed in the groove before compression of the bipolar plates in order to orientate the bipolar plates relative to the membrane electrode assembly in a defined manner and to centre them.

It is an object of the present invention to provide an improved fuel cell of the type defined at the beginning, an improved fuel cell stack and an improved method for sealing a fuel cell.

This object is achieved through a fuel cell having the features of claim 1. This object is further achieved through a fuel cell stack having the features of claim 13 and through methods having the features of claim 14. Advantageous embodiments with useful developments of the invention are indicated in the respectively dependent claims.

The inventive fuel cell comprises a membrane electrode assembly which is disposed between two distribution elements. A first of the two distribution elements serves to impact an anode of the membrane electrode assembly with a fuel. The second distribution element serves to impact a cathode of the membrane electrode assembly with an oxidising agent. A sealing element is connected to the membrane electrode assembly. The sealing element and at least one of the distribution elements are hereby brought into contact at least in areas so that an abutment region is formed. A sliding surface is provided in the abutment region, by means of which, upon compression of the two distribution elements, the membrane electrode assembly disposed between the two distribution elements can be impacted with a shear stress.

If when the two distribution elements are compressed in the direction towards each other a pressure acts perpendicularly on the planar membrane electrode assembly (MEA) the shear stress, with which the membrane electrode assembly is impacted, acts tangentially to the membrane electrode assembly. Upon compression of the distribution elements the membrane electrode assembly arranged between them can be stressed in the direction of the shear stress. In the non-compressed state of the fuel cell, thus before compression of the two distribution elements, an area taken up by the membrane electrode assembly and the sealing element connected thereto is smaller than an area in the compressed state, in which the two distribution elements are compressed. Through the sliding caused upon compression of the two distribution elements along the sliding surface the membrane electrode assembly can be conveyed into a defined stress state.

A defined seal can thereby be achieved between the membrane electrode assembly and the respective distribution element and also a defined seal between the two distribution elements. Unsealed areas can thus be avoided particularly reliably and in particular over a long operating period of the fuel cell to a great extent. The sealing element disposed in this way between the distribution elements additionally ensures a particularly good insulation of the distribution elements from one another.

Such a fuel cell facilitates a cost-effective, particularly process-reliable and reproducible assembly. In addition the fuel cell has a particularly long lifespan.

In an advantageous embodiment of the invention the sliding surface is provided as a chamfer on the sealing element. Upon compression of the two distribution elements at least one of the distribution elements hereby slides down along the chamfer and thus impacts the membrane electrode assembly with the shear stress.

Alternatively, but preferably additionally, a further sliding surface is provided as a chamfer on at least one of the two distribution elements. In particular it is advantageous if the two distribution elements comprise the chamfer which correlates with a respective chamfer on the sealing element. Upon compression of the two distribution elements the chamfers then slide along on each other and thus cause the stressing of the membrane electrode assembly. The provision of the chamfers both on the sealing element and on the two distribution elements thereby simplifies a particularly low-friction sliding along of the chamfers.

It is hereby particularly advantageous if in the direction of the shear stress a length of the chamfer on the sealing element is equal to a length of the chamfer on the distribution element. A comparatively large sliding surface is thereby provided which facilitates a particularly extensive reduction of the sliding friction of the chamfers.

It has been shown to be further advantageous if an abutment surface is adjacent to at least one end of the at least one sliding surface in the direction of the shear stress. This abutment surface is preferably planar. Furthermore planar abutment surfaces can be adjacent to both ends of the sliding surface. Such an abutment surface provides—in the compressed state of the fuel cell —a further abutment region between the sealing element and at least one of the distribution elements so that through the sealing element a particularly wide sealing area is provided in the direction of the shear stress.

If the abutment surface is formed to be planar a particularly high sealing force can be achieved upon compression of the distribution elements with the membrane electrode assembly disposed between the two distribution elements in the region of the abutment surface. In particular a constant and constantly high surface pressure can thus be achieved between the sealing element and the distribution elements upon compression of the distribution elements.

If the at least one sliding surface is formed surrounding the membrane electrode assembly a surrounding and defined stressing of the membrane electrode assembly occurs upon impacting the membrane electrode assembly with the shear stress. The sealing element connected to the membrane electrode assembly thereby preferably experiences, upon compression of the distribution elements, an equidistant surrounding peripheral enlargement.

In a further advantageous embodiment of the invention a frame for the membrane electrode assembly which is in particular bend-resistant is provided through the sealing element. The membrane electrode assembly with the sealing element connected thereto is thus particularly easy to handle.

It has been shown to be further advantageous if the sealing element, in particular comprising an elastomer, is welded to the membrane electrode assembly. The connection of the membrane electrode assembly comprising a polymer electrolyte membrane (PEM) with the sealing element by a plastic welding process ensures a particularly reliable connection of the sealing element with the membrane electrode assembly resistant to the shear stress upon compression of the distribution elements. The elastic sealing element can be formed as a thermoplastic elastomer and/or comprise rubber and/or silicone material.

A particularly simple assembly of the fuel cell by arranging the distribution elements and the membrane electrode assembly with the sealing element can be achieved when the respective distribution element has a symmetry plane parallel to the membrane electrode assembly. Upon assembly any side of the distribution element can face the membrane electrode assembly. For the simple and operationally reliable assembly of the fuel cell it is additionally advantageous if the two distribution elements are equal to each other in form and dimensions.

In a further advantageous embodiment of the invention a distribution area for a reaction agent is provided through at least one of the distribution elements in at least one edge region adjacent to the sealing element in cooperation with the membrane electrode assembly. In the compressed state of the distribution elements with the membrane electrode assembly disposed between them an intermediate area with a constant, defined height is thus advantageously provided between the membrane electrode assembly and the distribution element. Through the provision of such an intermediate area with a defined height, through which the oxidising agent or the fuel can flow, the through-flow of the fuel cell with the reaction agent can be guaranteed particularly well and be reproduced particularly well. In particular the electrochemical reactions can thereby be controlled particularly well. In particular the constancy thereof can be guaranteed over a particularly long period.

It is particularly preferable for one of the distribution elements to comprise at least on a side facing the membrane electrode assembly a plurality of ribs, in particular parallel to each other. In the compressed state of the distribution elements with the membrane electrode assembly arranged between them the ribs are then brought into abutment with the membrane electrode assembly so that a constant surface pressure between the distribution element and the membrane electrode assembly can be achieved particularly well.

Finally it has been shown to be advantageous if the distribution elements are electrically conductive. The distribution elements thus serve not only to distribute the reaction agent on the anode or the cathode but instead in particular to contact a plurality of fuel cells coupled with each other via the electrically conductive distribution elements.

The advantages of the invention are thus shown in particular in a fuel cell stack which comprises a plurality of inventive fuel cells. Indeed if a comparatively large number, for example 200 to 350 individual fuel cells are to form the fuel cell stack the defined stressing of the respective membrane electrode assemblies can be usefully applied through the sliding surface provided in the abutment region. Through the impacting of the individual membrane electrode assemblies with the shear stress a high degree of sealing of the fuel cell stack and a constant surface pressure can be achieved. Also undefined flow-specific channel cross-section tapering and undefined length extensions can thus be avoided.

When constructing the fuel cell stack from individual fuel cells a distribution element is in contact within the fuel cell stack with a membrane electrode assembly disposed on the upper side of the distribution element and with a membrane electrode assembly arranged on the lower side of said distribution element. In other words one and the same distribution element delimits two respective membrane electrode assemblies of adjacent fuel cells from each other. Merely in case of the lowermost and the uppermost membrane electrode assemblies in the stack does the distribution element form a connection to an outer side of the stack.

According to a further aspect of the invention an improved method is provided for sealing a fuel cell, wherein a membrane electrode assembly is connected to a sealing element and wherein the membrane electrode assembly is disposed between a first distribution element for impacting an anode of the membrane electrode assembly with a fuel and a second distribution element for impacting a cathode of the membrane electrode assembly with an oxidising agent with the formation of an abutment region. Upon compression of the two distribution elements at least one of the two distribution elements and the sealing element slide along on each other, whereby the membrane electrode assembly disposed between the distribution elements is impacted with a shear stress. The membrane electrode assembly is thereby stressed in the direction of the shear stress, thus perpendicular to the force acting upon compression of the two distribution elements.

The preferred embodiments and advantages described for the inventive fuel cell also apply to the inventive fuel cell stack and also to the inventive method.

The features and feature combinations mentioned above in the description and the features and feature combinations mentioned below in the description of the drawings and/or shown solely in the drawings cannot only be used in the respectively indicated combination but also in other combinations or alone without going outside of the scope of the invention.

Further advantages, features and details of the invention follow from the claims, the following description of preferred embodiments and by reference to the drawings, in which:

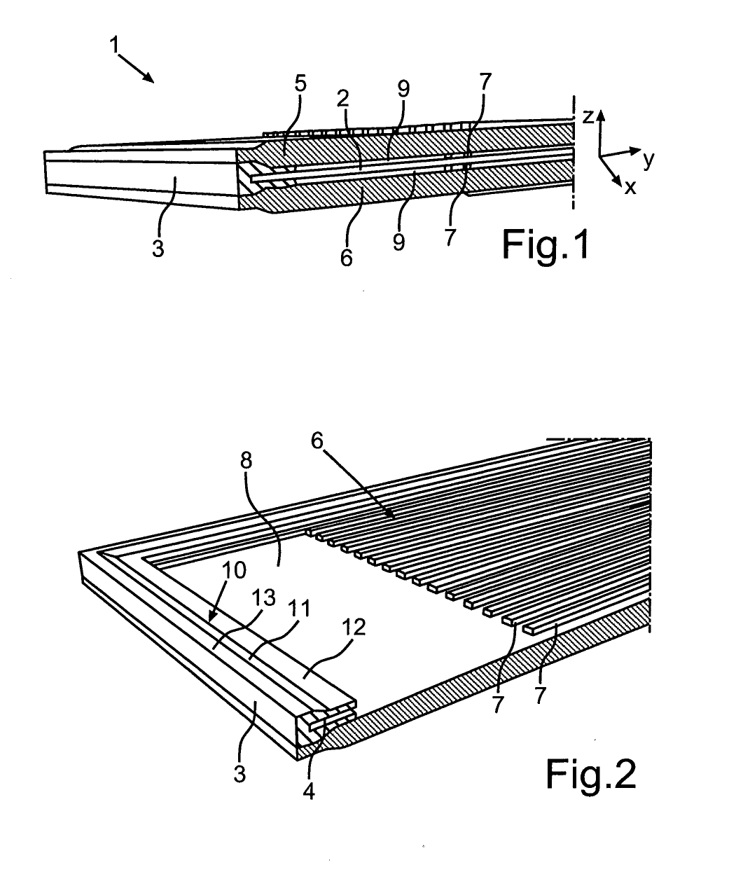

FIG. 1 shows in a cut-out a perspective sectional view of a fuel cell, in which a membrane electrode assembly is held in a stressed manner in an extension plane of the membrane electrode assembly between two bipolar plates,

FIG. 2 in a cut-out, a bipolar plate of the fuel cell according to FIG. 1 with a sealing frame arranged on the bipolar plate; and

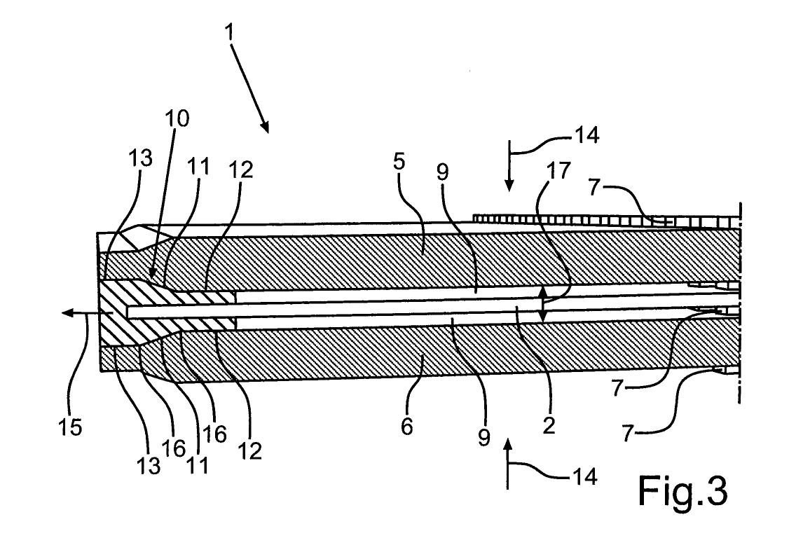

FIG. 3 an enlarged perspective sectional view of an edge region of the fuel cell according to FIG. 1.

FIG. 1 shows in a perspective sectional view a fuel cell 1 of a fuel cell stack. The fuel cell 1 comprises a membrane electrode assembly 2, wherein a polymer electrolyte membrane (PEM) separates a cathode from an anode. The planar membrane electrode assembly 2 extending flat in the direction of an X-Y plane is connected in particular by welding to a sealing frame 3. The membrane electrode assembly 2 is hereby introduced into a groove 4 formed in the sealing frame 3 (cf FIG. 2).

The sealing frame 3 consists of an elastomer and is in abutment according to FIG. 1 with a first bipolar plate 5 and with a second bipolar plate 6. The bipolar plates 5, 6 serve as distribution elements for impacting the anode of the membrane electrode assembly 2 with a fuel and for impacting a cathode of the membrane electrode assembly 2 with an oxidising agent. The bipolar plates 5, 6 thereby ensure that the reaction agent supplied to the fuel cell 1 is distributed evenly and a continuous electrochemical reaction is distributed favourably to the respective electrodes.

Ribs 7 thereby stand away from each of the bipolar plates 5, 6 in the direction of a Z axis which is perpendicular to the X-Y plane. Channels for the reaction agent are thereby formed between the ribs 7 parallel to each other. The ribs 7 thereby stand both in the direction of the Z axis and in a direction opposite the direction of the Z axis away from the bipolar plates 5, 6. The bipolar plates 5, 6 are respectively symmetrical relative to a symmetry plane which is parallel to the X-Y plane.

In an edge region 8 of the bipolar plates 5, 6 adjacent to the sealing frame 3 there are no ribs (cf FIG. 2) so that a distribution area 9 for the respective reaction agent is provided in this edge region 8 in the fuel cell 1 in cooperation with the membrane electrode assembly 2. A height of the distribution area 9 hereby corresponds to a height of the ribs 7.

It can be seen in particular from FIG. 2, which shows the lower bipolar plate 6 with the sealing frame 3 disposed thereon but without the membrane electrode assembly 2 in a sectional view, that an abutment region 10, in which the sealing frame 3 and the bipolar plates 5, 6 are in contact, comprises a chamfer 11. The chamfer 11 of the sealing frame 3 is adjacent inwardly to a first planar abutment surface 12. Furthermore the sealing frame 3 comprises a further, also planar, abutment surface 13 adjacent outwardly to the chamfer 11. The chamfer 11 thus comprises an inclination to the X-Y plane while the abutment surfaces 12, 13 are parallel to the X-Y plane.

Corresponding chamfers 11 and abutment surfaces 12, 13 are provided on the bipolar plates 5, 6, of which the function upon assembly of the fuel cell 1 is described having regard to FIG. 3.

Upon assembly of the fuel cell 1 initially the membrane electrode assembly 2 is connected to the sealing frame 3 by welding. The sealing frame 3 which is rectangular in the present case hereby surrounds the membrane electrode assembly 2. In the still non-compressed state of the fuel cell 1, thus before impacting of the bipolar plates 5, 6 with a pressing force 14 illustrated in FIG. 3 by force arrows, an area extension of a component group which comprises the membrane electrode assembly 2 and the sealing frame 3 connected thereto is smaller than the respective area extension of the bipolar plates 5, 6. After pressing of the fuel cell 1, thus after compression of the bipolar plates 5, 6, and the membrane electrode assembly 2 disposed between them by impacting the bipolar plates 5, 6 with the pressing force 14, however, the sealing frame 3 ends in the direction of the X-Y plane flush with the bipolar plates 5, 6. The component group thus undergoes, following the impacting of the bipolar plates 5, 6 with the pressing force 14, an equidistant area enlargement. This area enlargement goes hand in hand with a defined stressing of the membrane electrode assembly 2 in the X-Y plane.

Upon compression of the bipolar plates 5, 6, the chamfers 11 provided on the sealing frame 3 and on the bipolar plates 5, 6 slide along on each other until the respective abutment surfaces 12, 13 of the sealing frame 3 and the bipolar plates 5, 6 lie on top of each other. The sliding along of the chamfers 11 on each other causes an impacting of the membrane electrode assembly 2 with a shear force 15, thus with a force stressing the membrane electrode assembly 2, which acts tangentially to the X-Y plane. The shear force 15 is illustrated in FIG. 3 by a further force arrow. An end of the chamfer 11 serving as a sliding surface in the direction of the shear force 15 is formed in the present case by a bend 16. The bend 16 thus delimits the chamfer 11 from the respective abutment surfaces 12, 13.

As soon as the respective abutment surfaces 12, 13 of the bipolar plates 5, 6 and of the sealing frame 3 are in abutment with each other the pressing force 14 acts on bipolar plates 5, 6 as a sealing force on these abutment surfaces 12, 13. A seal over the whole area and thus guaranteeing a particularly high level of sealing is thus provided over the whole side of the sealing frame 3 facing the respective bipolar plate 5, 6. Through the sealing frame 3 the bipolar plates 5, 6 are additionally electrically insulated from each other in the pressed state of the fuel cell 1.

An interval 17 between the bipolar plates 5, 6 can be set in a defined manner and constantly over the whole area of the fuel cell 1 after compression of the bipolar plates 5, 6 and the bringing into abutment of the abutment surfaces 12, 13 so that the distribution areas 9 of the fuel cell 1 also have a constant height extension.

This is guaranteed on the one hand through the forms and dimensions of the chamfers 11 and the abutment surfaces 12, 13 on the sealing frame 13 and on the bipolar plates 5, 6 which are equal to each other and on the other hand through the defined height of the ribs 7, which in the pressed state of the fuel cell 1 are in abutment with the membrane electrode assembly 2.

The procedure described in the present case using the example of an individual fuel cell 1 in the production of a frame distance stress sealing of the membrane electrode assembly 2 via the sealing frame 3 can be used particularly advantageously in the construction of a fuel cell stack. During construction of the fuel cell stack a large number of membrane electrode assemblies 2 and bipolar plates 5, 6 are stacked alternately one on top of the other and subsequently tensioned by impacting the outer lying bipolar plates 5, 6 with the pressing force 14. The respective membrane electrode assemblies then lie in the fuel cell stack 2 in a defined stress state, in which the respective sealing frames 3 end flush with the bipolar plates 5, 6.

### LIST OF REFERENCE NUMERALS

1 Fuel cell
2 Membrane electrode assembly
3 Sealing frame
4 Groove
5 Bipolar plate
6 Bipolar plate
7 Rib
8 Edge region
9 Distribution area
10 Abutment region
11 Chamfer
12 Abutment region
13 Abutment region
14 Pressing force
15 Shear stress
16 Bend
17 Interval

1. A fuel cell with a membrane electrode assembly (2) which is disposed between a first distribution element (5) for impacting an anode of the membrane electrode assembly (2) with a fuel and a second distribution element (6) for impacting a cathode of the membrane electrode assembly (2) with an oxidising agent, and with a sealing element (3) which is connected to the membrane electrode assembly (2),
wherein the sealing element (3) and at least one of the distribution elements (5, 6) are contacted at least in areas and an abutment region (10) is thereby formed, and
wherein a sliding surface (11) is provided in the abutment region (10), by means of which upon compression of the two distribution elements (5, 6) the membrane electrode assembly (2) disposed between the two distribution elements (5, 6) can be impacted with a shear force (15).

2. The fuel cell according to claim 1, wherein a sliding surface is provided as a chamfer (11) on the sealing element (3).

3. The fuel cell according to claim 1, wherein a further sliding surface is provided as a chamfer (11) on at least one of the two distribution elements (5, 6).

4. The fuel cell according to claims 2, wherein a length of the chamfer (11) on the sealing element (3) in the direction of the shear stress (11) is equal to a length of the chamfer (11) on the distribution element (5, 6).

5. The fuel cell according to claim 1, wherein an abutment surface (12, 13), which is planar, is adjacent to at least one end (16) of the at least one sliding surface (11) in the direction of the shear stress (15).

6. The fuel cell according to claim 1, wherein the at least one sliding surface (11) is formed around the membrane electrode assembly (2).

7. The fuel cell according to claim 1, wherein a frame (3) is provided for the membrane electrode assembly (2) through the sealing element.

8. The fuel cell according to claim 1, wherein the sealing element (3) is welded to the membrane electrode assembly (2).

9. The fuel cell according to claim 1, wherein the distribution elements (5, 6) respectively have a symmetry plane parallel to the membrane electrode assembly (2).

10. The fuel cell according to claim 1, wherein a distribution area (9) for a reaction agent is provided through at least one of the distribution elements (5, 6) in at least an edge region (8) adjacent to the sealing element (3) in cooperation with the membrane electrode assembly (2).

11. The fuel cell according to claim 1, wherein one of the distribution elements (5, 6) comprises a plurality of ribs (7) at least on a side facing the membrane electrode assembly (2).

12. The fuel cell according to claim 1, wherein the distribution elements (5, 6) are electrically conductive.

13. The fuel cell stack, wherein the fuel cell stack comprises a plurality of fuel cells (1) according to claim 1.

14. A method for sealing a fuel cell (1), wherein
a) a membrane electrode assembly (2) is connected to a sealing element (3), and
b) the membrane electrode assembly (2) is disposed between a first distribution element (5) for impacting an anode of the membrane electrode assembly (2) with a fuel and a second distribution element (6) for impacting a cathode of the membrane electrode assembly (2) with an oxidising agent with the formation of an abutment region (10), the method comprising:
compressing the two distribution elements (5, 6) such that at least one of the two distribution elements (5, 6) and the sealing element (3) slide along on each other, and
impacting the membrane electrode assembly (2) disposed between the two distribution elements (5, 6) with a shear stress (15).

15. A method according to claim 14, wherein it is carried out on a fuel cell (1) according to claim 1.

16. The fuel cell according to claim 1, wherein a planar abutment surface (12, 13) is adjacent to at least one end (16) of the at least one sliding surface (11) in the direction of the shear stress (15).

17. The fuel cell according to claim 1, wherein a bend-resistant frame (3) is provided for the membrane electrode assembly (2) through the sealing element.

18. The fuel cell according to claim 1, wherein the sealing element (3), comprising an elastomer, is welded to the membrane electrode assembly (2).

19. The fuel cell according to claim 1, wherein the distribution elements (5, 6), equal to each other in form and dimensions, respectively have a symmetry plane parallel to the membrane electrode assembly (2).

20. The fuel cell according to claim 1, wherein one of the distribution elements (5, 6) comprises a plurality of ribs (7) parallel to each other at least on a side facing the membrane electrode assembly (2).
